(19) United States
(12) Patent Application Publication
(10) Pub. No.: US 2013/0260976 A1
(43) Pub. Date: Oct. 3, 2013

(54) Laminate For Use In Packages, A Method Of Making A Reclosable Laminate And Use Thereof

(71) Applicants: Palle Schmidt, Slagelse (DK); Peter Johansen, Slagelse (DK); Else Dydensborg, Slagelse (DK); Ole Brødsgaard, Slagelse (DK); Benjamin Waedeled, Slagelse (DK); Lars Christensen, Slagelse (DK)

(72) Inventors: Palle Schmidt, Slagelse (DK); Peter Johansen, Slagelse (DK); Else Dydensborg, Slagelse (DK); Ole Brødsgaard, Slagelse (DK); Benjamin Waedeled, Slagelse (DK); Lars Christensen, Slagelse (DK)

(73) Assignee: Danapak Flexibles A/S, DK-4200 Slagelse (DK)

(21) Appl. No.: 13/885,069

(22) PCT Filed: Nov. 8, 2011
(86) PCT No.: PCT/DK2011/000130

§ 371 Date: Jun. 7, 2013

(30) Foreign Application Priority Data
Nov. 11, 2010 (DK) PCT/DK2010/000146

(51) Int. Cl. B31B 1/62

(52) U.S. Cl. CPC B31B 1/62
USPC 493/128; 427/208.2

(57) ABSTRACT

A laminate for use in packages comprises a base layer (3), a welding layer (1), and an adhesive layer (2) sandwiched there between. The adhesive layer (2) is a hot melt or a pressure sensitive adhesive (PSA) having a shear rate of 10-150 minutes at 40° C. in a test area of 12.5 mm×25 mm. The welding layer (1) comprises a layer of a polyethylene (PE) copolymer, and optionally an additional layer of PET, PE, such as low density polyethylene (LDPE) and/or PP. The method of making the laminate involves applying a base layer (3), an adhesive layer (2) of hot melt/PSA and subsequently a welding layer (1) in one working process to form a reclosable laminate (9). This laminate may serve as a reclosable lid and exhibits a reduced risk of cracks or so-called piping in the laminate.

### TECHNICAL FIELD

The invention relates to a method of making a reclosable laminate, such as a lid film for packages, as well as use of the laminate.

### THE PRIOR ART

WO 02/055300 A1 describes a laminate in which a pressure sensitive adhesive (PSA) is sandwiched between a substrate layer and a sealant layer of polypropylene (PP). In a prior art laminate disclosed therein, polyethylene (PE) is used instead of PP in the sealant layer. This known laminate tends to delaminate between the PSA layer and the PE sealant layer, which causes formation of cracks, or so-called “piping”, on the film when the sealant layer is separated from the PSA layer.

A known method described in EP 2108507 A1 comprises advancing a base sheet to an intaglio printing roller and applying the adhesive layer, the reclosure layer, during this process. This adhesive layer is normally a water-based adhesive, and, consequently, the water must be dried before the next process in the form of the application of a layer can be carried out.

This last application comprises depositing a welding layer on top of the adhesive layer, partly in order to allow storage of the laminate for later use, partly in order to protect the adhesive layer.

Thus, this process is both time-consuming and cumbersome, partly because of the drying need, partly because of the exposed adhesive layer, before a protective layer is applied to this in the final phase.

Another known method of making a reclosable laminate is in the manufacture in a so-called blowing extrusion, where a film and also an adhesive layer of a pressure sensitive adhesive (PSA) are extruded in an extruder.

This method requires that the materials used are extrudable up to about 250° C., and also that this takes place in a multilayer extruder.

The drawback of this method is that it is relatively slow, since an additional working process is required in the manufacture, as, for one thing, a film with a reclosure layer has to be extruded, and, for another, the reclosure film must subsequently be laminated to a base film. To this should be added that the materials with which this laminate must be capable of being connected, i.e. the package part itself, are limited to such materials as can be welded together with the laminate.

### SUMMARY OF THE INVENTION

It is the object of the invention to simplify and thereby reduce the costs of a method of making such a reclosable laminate, and this is achieved by a method in which first an adhesive layer of hot melt is applied via a roller or is sprayed to the base layer during feeding of the base layer, and that immediately thereafter a welding layer, which comprises a layer of polyethylene co-polymer, is extruded on top of the adhesive layer.

In this manner, it is possible to save drying time when using hot melt as an adhesive, since the adhesive is cooled more quickly and sufficiently for a cover layer to be applied, whereby the manufacture may take place in one run, and, thus, the laminate is manufactured more quickly and readily than by the previously known method. To this should be added that there will be fewer limitations in the selection of materials of which the package part itself, the lower web, may be made in order to allow welding to the laminate.

When the adhesive layer is applied directly to the base layer by the supply of the heated and thereby liquid adhesive, either via direct application or via a spray process, application may take place directly on the advancing base sheet.

When a roller, which is slip-free on the surface, is used for the application of the adhesive layer, a very precise metering with a completely uniform distribution and dimension of the adhesive may be achieved.

The welding layer preferably comprises two sub-layers, which are coextruded on to the adhesive layer, and when this application is carried out in an all-in-one process on the advancing base layer, the production costs will be low compared to known methods.

In an expedient embodiment, the adhesive layer is applied in a thickness of 6-35 μm and preferably a thickness of 15-23 μm corresponding to approximately 12-18 g/m², and in a further expedient embodiment the welding layer is applied in a thickness of 8-20 μm or corresponding to approximately 10-20 g/m².

The (PE) homo- or copolymer in the welding layer is expediently a homo- or copolymer of PE, such as a homo- or copolymer of LDPE.

When the welding layer further comprises an additional outer layer of PET, PE, such as low density polyethylene (LDPE) and/or PP, proper welding of the laminate to sheets or containers made of or covered with layers of PET, PE or PP is ensured.

Finally, it is expedient to use the laminate as a lid sheet, precisely because it contains a welding layer for welding on a package, and with the property that this layer may be torn easily, so that the adhesive layer is exposed at the tearing operation. This ensures that the laminate, i.e. lid film, may be joined again with the lower part of the package, e.g. a sheet, a container or a tray, to form the assembled package when the separated parts are joined again at the closing of the package.

### BRIEF DESCRIPTION OF THE DRAWINGS

Examples of the method as well as the use of the laminate will be described more fully below with reference to the drawings, in which

FIG. 1 shows the principle of application of a reclosure layer via an applicator unit, in a sectional view,

FIG. 2 shows the principle of indirect application of a reclosure layer via a roller, in a sectional view,

FIG. 3 shows the use of the laminate according to the invention as a lid film, in a sectional view, and

FIG. 4 shows a perspective view of a package with a lid film welded thereon.

### DETAILED DESCRIPTION OF THE INVENTION

When packing food products or the like, it is common practice to use a lid film which is sealed by heat to a second sheet or sealed by heat to a rim area of a container, e.g. a tray-shaped container.

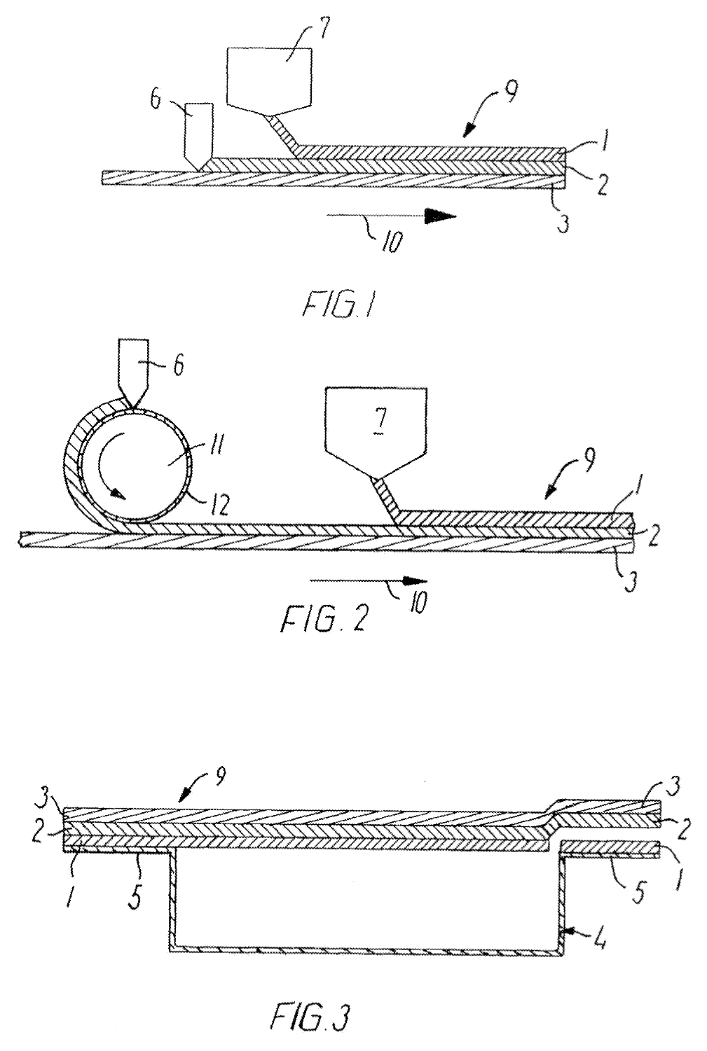

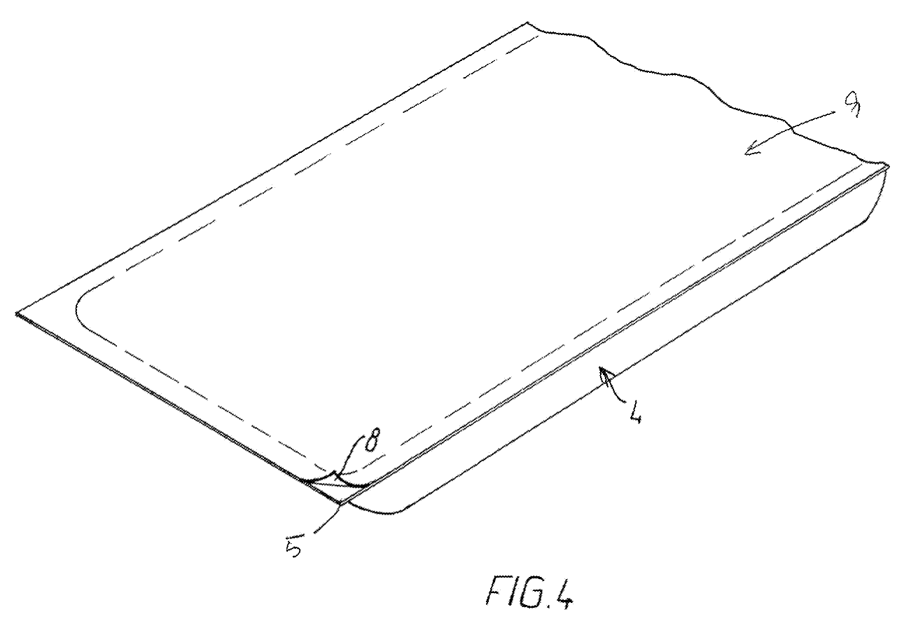

As shown in FIG. 3, the lid film according to the invention is a reclosable laminate film 9, which comprises a base layer 3, a welding layer 1 and an adhesive layer 2 between the base layer 3 and the welding layer 1.

The composition of the base layer 3 depends entirely on the requirements which the finished product, the reclosable laminate 9, is to meet in order to protect the packaged product, such as a food product.

Thus, the base layer 3 may be a film of a homo- or copolymer of oriented polypropylene (OPP), oriented polyamide (OPA), polyethylene (PE), polyethylene terephthalate (PET) or combinations thereof. In addition, the base layer 3 may be a laminate of two or more layers of the described materials. The base layer 3 may thus comprise one or more additional layers serving as a light barrier, such as paper and/or aluminium (Al) layers; aroma barriers, such as a PET layer with a silicon oxide (SiOx) or aluminium oxide (AlOx) coating or an aluminium (Al) layer; water vapour barriers, such as e.g. OPP, or any combination thereof. These additional layers may be applied to the free surface of the base layer 3. The skilled person will be able to choose suitable materials of the additional layers applied for achieving a tight packaging material in respect of light, aroma and/or water vapour. Hereby, all requirements with respect to barrier, transparency, pressure, print, etc. may be met, i.e. the base layer 3 may also serve as a barrier layer.

The hot melt/PSA in the adhesive layer 2 is applied in a thickness of 6-35 μm, which corresponds to approximately 5-30 g/m², and preferably in a thickness of approximately 15-23 μm corresponding to 12-18 g/m².

In order to ensure proper adhesion to the other layers in the reclosable laminate 9, and especially to the PE-containing surface of the welding layer 1, it has been found to be especially preferred that the hot melt or PSA used has a shear rate of approximately 10-150 minutes at 40° C. according to the international standard method for shear adhesion in pressure sensitive tape (PSTC 107) using a load of 1000 g at 40° C. in a test area of 12.5 mm×25 mm. The preferred shear rate is between 30-70 minutes at 40° C. When using a hot melt/PSA adhesive layer 2 having a shear rate as just described, the formation of cracks or “piping” in the laminate as described above is surprisingly found to be significantly reduced or even eliminated, also in a reclosable laminate 9 in which the hot melt or PSA is in direct contact with a PE containing surface of the welding layer.

The welding layer 1 preferably comprises a sub-layer of PE homo or co-polymer, which may be coextruded with an additional layer of PET, PE, such as low density polyethylene (LDPE) and/or PP. The PE homo- or co-polymer sub-layer in the welding layer serves as an adhesion surface towards the adhesive layer 2 and may serve as a welding layer 1 if no additional sub-layer is present. If an additional sub-layer is present it serves as welding surface towards the sheet or the package on which the reclosable laminate 9 is applied, e.g. as a lid. The welding layer 1 preferably has a thickness of 8-20 μm or corresponding to approximately 10-20 g/m² depending on the density of the polymer layer(s) used.

If a PET sub-layer is present in the welding layer 1, the reclosable laminate 9 may be applied to packaging materials, e.g. sheets or containers, trays or the like made of PET or having a surface layer of PET; if a PP sub-layer is present in the welding layer 1, the reclosable laminate 9 may be applied to packaging materials, e.g. sheets or containers, trays or the like made of PP or having a surface layer of PP; and if a LDPE sub-layer is present in the welding layer 1, the reclosable laminate 9 may be applied to any packaging material made of PE or to which a surface layer containing PE, e.g. a LDPE, is applied.

In a preferred embodiment of the reclosable laminate 9, the welding layer 1 consists of one of the following combinations:
PE copolymer/PET; the total thickness of the welding layer being approximately 10 μm or corresponding to 12 g/m², the PET sub-layer having a thickness of 3-4 μm or 4-6 g/m²,
PE copolymer/PP; the total thickness of the welding layer being approximately 10 μm or corresponding to 12 g/m², the PP sub-layer having a thickness of 3-4 μm or 4-6 g/m²,
PE copolymer/LDPE; the total thickness of the welding layer being approximately 10 μm or corresponding to 12 g/m², the LDPE sub-layer having a thickness of 3-4 μm or 4-6 g/m² or
LDPE homo- or copolymer present as one unitary layer for contact to the PSA or hot melt and as a welding layer; the total thickness of the welding layer being approximately 10 μm or corresponding to 12 g/m².

The composition of the PE-copolymer is less important for obtaining a laminate in which formation of cracks or piping is reduced or eliminated. Thus, a PE homopolymer, such as, but not restricted to LDPE is also useful in obtaining the desired reduction or elimination of piping in the laminate. It appears that the most important parameter for reducing the piping in the laminate is the shear rate for the hot-melt or PSA as described above, especially in a re-closable laminate having a welding layer with a thin layer of PE containing polymer applied on the hot melt or PSA layer.

As examples of application amounts, thicknesses, it may be mentioned that if the base layer 3 in use is an OPP solution, it may have a layer thickness of 20 μm corresponding to 18-20 g/m². In case the base layer 3 is made of PE, the thickness will be in the range of 10-15 μm corresponding to approximately 10 g/m². In case of a base layer 3 of PET, the thickness of the base layer 3 may be 8-12 μm corresponding to 11.2-20 g/m², and preferably 10-12 μm corresponding to 14-20 g/m².

The welding layer 1 is preferably a layer of PE copolymer/PET as described above in combination with either of the above-mentioned base layers 3.

Methods according to the invention of making a reclosable laminate 9 which may be used as a reclosable lid on the package, will be described with reference to FIG. 1 and FIG. 2, respectively.

As a starting point for the manufacture, the methods use a base layer 3 which is advancing continuously, as indicated by the arrow 10, in the performance of the method.

An adhesive layer 2 is then applied, as shown in FIG. 1, by means of an applicator unit 6, the adhesive layer 2 being applied on the advancing base layer 3 and in liquid form of a hot melt or a pressure sensitive adhesive (PSA).

The applicator unit 6 may comprise a generally known applicator nozzle, which applies the hot melt/PSA adhesive either by direct contact, or in that the adhesive is sprayed onto the base layer 3.

Since the hot melt adhesive layer 2 will cool quickly on the base layer 3, a welding layer 1 may be coextruded immediately thereafter via a coextruder 7, the PE homo- or copolymer sub-layer of the welding layer 1 being applied directly to the surface of the adhesive layer 2. Hereby, the welding layer 1 also serves as a protection layer for the adhesive layer 2.

FIG. 2 shows another method by which the hot melt/PSA is applied to the base layer 3 from a nozzle 6 of an applicator roller 11. The surface of the roller is made adhesion-free by the application of a silicone layer 12. Hereby, it is possible to ensure a completely even and precisely distributed adhesive layer 2.

The method ensures that a reclosable laminate 9 according to the invention may be made in a single procedure, and the use of hot melt, which melts and cools quickly, allows it to recover its adhesion power, which is necessary to ensure that the adhesive and thereby the reclosure effect are optimum.

The use of the reclosable laminate 9 made by the method will now be described with reference to FIG. 3 and FIG. 4.

In the example shown, the reclosable laminate 9 is welded to a lower web 5, which may be the rim area on a container 4, e.g. a tray, as shown in FIG. 4. This reclosable laminate layer 9 covers the package as a lid. A corner section 8 is indicated in FIG. 4 to show that the film may be gripped and lifted when being pulled off.

As indicated to the right in FIG. 3, when the package is opened, the reclosable laminate 9, in which the base layer 3 also serves as a barrier layer, will be separated: The welding layer 1 will remain on the base layer 3 and the adhesive layer 2, except in the area where the reclosable laminate 9 has been welded to the lower web 5. In this area, the welding layer 1 will remain on the lower web 5.

The adhesive layer 2, i.e. the hot melt/PSA, which enables reclosure of the package, will remain on the base layer 3, as shown, or alternatively—not shown—it may also remain on top of the welding layer 1 remaining on the lower web 5, e.g. the sheet, or the rim of the container or the tray, after opening of the package.

The adhesive layer 2 is exposed hereby, and the reclosable lid may be closed again by joining this part of the adhesive layer 2 with the rest of the laminate.

In this manner, the laminate may serve as a reclosure layer, e.g. a lid film, and since the adhesive is intact and protected, this reclosure will operate for the entire service life of the package.

1. A laminate for use in packages comprising a base layer and a welding layer, and an adhesive layer sandwiched there between, characterized in that the adhesive layer (2) is a hot melt or a pressure sensitive adhesive (PSA) having a shear rate of 10-150 minutes at 40° C. using a load of 1000 g at 40° C. in a test area of 12.5 mm×25 mm, and that the welding layer (1) comprises a layer of a polyethylene (PE) homo- or copolymer.

2. A laminate according to claim 1, characterized in that the adhesive layer (2) has a shear rate of 30-70 minutes at 40° C. using a load of 1000 g at 40° C. in a test area of 12.5 mm×25 mm.

3. A laminate according to claim 1, characterized in that the adhesive layer (2) has a thickness of 6-35 μm and preferably a thickness of approximately 15-23 μm corresponding to 12-18 g/m².

4. A laminate according to any one of claims 1-3, characterized in that the (PE) homo- or co-polymer in the welding layer (1) is a homo- or co-polymer of PE, such as a homo- or copolymer of LDPE.

5. A laminate according to any one of claims 1-4, characterized in that the welding layer (1) further comprises an additional layer of PET, PE, such as low density polyethylene (LDPE) and/or PP.

6. A laminate according to any one of claims 1-4, characterized in that the welding layer (1) preferably has a thickness of 8-20 μm or corresponding to approximately 10-20 g/m².

7. A method of making a reclosable laminate, such as a lid film for packages, said laminate comprising a base layer, characterized in that an adhesive layer (2) of hot melt/PSA is applied to the base layer (3) during feeding (10), following which a welding layer (1) is extruded on the adhesive layer (2).

8. A method according to claim 7, characterized by applying the adhesive layer (2) directly to the base layer (3).

9. A method according to claim 7, characterized by applying the adhesive layer (2) via a roller (11) to the base layer (3).

10. A method according to any one of claims 7-9, characterized by the welding layer (1) comprising two sub layers, which are coextruded on to the adhesive layer (2).

11. A method according to any one of claims 7-10, characterized in that the application of the hot melt or PSA (2) and the welding layer (1) takes place in one working operation during the feeding (10) of the base layer (3).

12. Use of the laminate according to any one of claims 1-6, characterized in that the welding layer (1) of the laminate (9) is welded firmly onto a lower web (5), such as the rim area (5) of a container or another sheet in a package, so that this layer (1) is broken when the laminate (9) is torn when opening the package and thereby exposing the adhesive layer (2), which remains either on the part of the welding layer (1) which remains on the lower web (5) when the package is opened, or remains on the base layer (3), following which the laminate (9) may be put together in order to close the package.
